(19) United States
(12) Patent Application Publication
(10) Pub. No.: US 2022/0294356 A1
(43) Pub. Date: Sep. 15, 2022

(54) POWER SUPPLY APPARATUS WITH SMOOTHING CAPACITOR AND IMAGE FORMING APPARATUS

(71) Applicant: CANON KABUSHIKI KAISHA, Tokyo (JP)

(72) Inventor: Yutaro Minami, Tokyo (JP)

(21) Appl. No.: 17/687,402

(22) Filed: Mar. 4, 2022

(30) Foreign Application Priority Data
Mar. 9, 2021 (JP) 2021-037804

(51) Int. Cl. H02M 3/335; H04N 1/00

(52) U.S. Cl. CPC H02M 3/33571; H04N 1/00891; H04N 1/00904

(57) ABSTRACT

A power supply apparatus for converting an AC voltage supplied from a power supply to a DC voltage includes a rectification circuit, a smoothing capacitor, a transformer, a voltage dividing circuit, and controller. The AC voltage is rectified by the rectification circuit and smoothed by the smoothing capacitor. The switching circuit switches between a first state in which the smoothed voltage is supplied to a first winding of the transformer and a second state in which the smoothed voltage is not supplied to the first winding. The voltage dividing circuit divides the smoothed voltage to a divided voltage by a ratio which depends on whether the AC voltage is being input to the power supply apparatus, and the divided voltage is applied to the controller. The controller controls the switching of the switching circuit according to the divided voltage applied from the voltage dividing circuit.

### BACKGROUND

### Technical Field

One disclosed aspect of the embodiments relates to a power supply apparatus configured to output a voltage and an image forming apparatus including the power supply apparatus.

### Description of the Related Art

An image forming apparatus is known which has an Alternating Current Direct Current (ACDC) conversion circuit configured to convert an AC voltage supplied from a commercial power supply into a DC voltage (US 2017/0176916). In the ACDC conversion circuit, a voltage obtained by rectification by a diode bridge is smoothed by a smoothing capacitor, and the smoothing capacitor is in a charged state.

When a failure occurs in some parts of the image forming apparatus, a serviceperson may replace a board provided in the ACDC conversion circuit. The replacing of the board is performed in a state where the AC voltage from the commercial power supply to the ACDC conversion circuit is cut off.

However, even when the AC voltage from the commercial power supply to the ACDC conversion circuit is cut off, there is a possibility that the smoothing capacitor is not yet sufficiently discharged. That is, there is a possibility that the board is replaced when the smoothing capacitor is not sufficiently discharged.

### SUMMARY

In view of the above problems, the present disclosure provides a technique of more efficiently discharging the smoothing capacitor in a state where the AC voltage from the commercial power supply is cut off.

In an aspect, the present disclosure provides a power supply apparatus configured to convert an AC voltage input from a commercial power supply to a DC voltage, including a rectification circuit, a smoothing capacitor, a transformer, a conversion circuit, a switching circuit, a voltage dividing circuit, and a controller. The rectification circuit is configured to rectify the AC voltage. The smoothing capacitor is configured to smooth the rectified AC voltage to generate a smoothed voltage. The transformer includes a first winding to which the smoothed voltage is applied, and a second winding isolated from the first winding. The conversion circuit is configured to convert a voltage, generated in the second winding caused by the smoothed voltage being applied to the first winding, into the DC voltage. The switching circuit is configured to switch between a first state in which the smoothed voltage is applied to the first winding and a second state in which the smoothed voltage is not applied to the first winding. The voltage dividing circuit is configured to divide the smoothed voltage to generate a divided voltage. The controller includes an input terminal to which the divided voltage is input and being configured to control switching between an ON state and an OFF state of the switching circuit in a state where the divided voltage is larger than a predetermined voltage. The voltage dividing circuit divides the smoothed voltage by a first voltage dividing ratio in a case where the AC voltage is being input to the power supply apparatus. The voltage dividing circuit divides the smoothed voltage by a second voltage dividing ratio larger than the first voltage dividing ratio in a case wherein the AC voltage is not being input to the power supply apparatus. Each of the first voltage dividing ratio and the second voltage dividing ratio is defined by a ratio of the divided voltage to the smoothed voltage.

Further features of the disclosure will become apparent from the following description of exemplary embodiments with reference to the attached drawings.

### BRIEF DESCRIPTION OF THE DRAWINGS

FIG. 1 is a cross-sectional view illustrating an image forming apparatus according to a first embodiment.

FIG. 2 is a control function block diagram of the image forming apparatus.

FIG. 3 is a block diagram illustrating a configuration of a power supply apparatus.

FIG. 4 is a diagram illustrating a current flowing through a primary winding of a transformer and a current flowing through a secondary winding of the transformer.

FIGS. 5A to 5D are time charts related to the operation of the power supply apparatus when the AC voltage input to the power supply apparatus is cut off.

### DESCRIPTION OF THE EMBODIMENTS

Embodiments of the present disclosure are described below with reference to the drawings. Note that the shapes of the components, their relative positions, and the like described in the following embodiments can be properly changed depending on the configuration of the specific apparatus to which the present disclosure is applied and various conditions, and the scope of the present disclosure is not limited by the following embodiments.

### First Embodiment

### Image Forming Apparatus

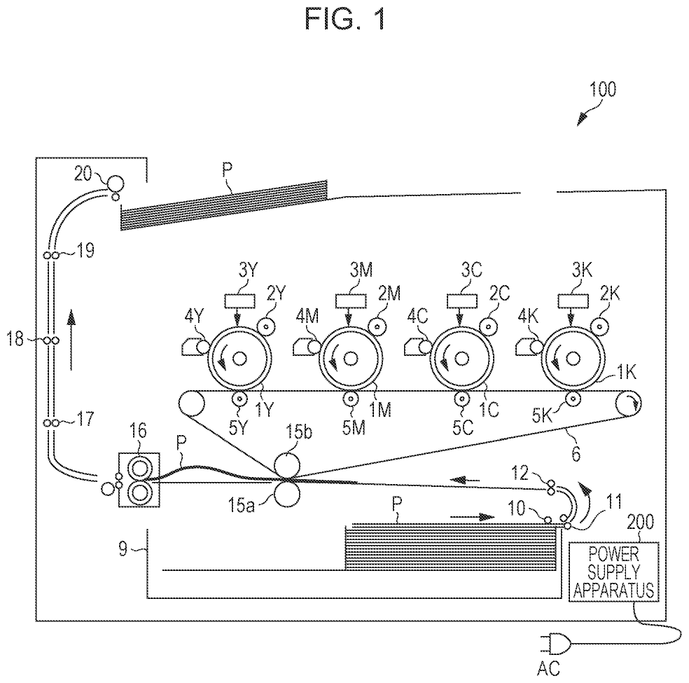

FIG. 1 is a cross-sectional view showing a configuration of a color electrophotographic copying machine (hereinafter referred to as an image forming apparatus) 100 including a sheet transport apparatus according to the present embodiment. The image forming apparatus is not limited to the copying machine. For example, the image forming apparatus may be a facsimile apparatus, a printing machine, a printer, or the like. The image forming method is not limited to the electrophotographic method, and other methods such as an inkjet method or the like may be employed. The type of the image forming apparatus may be either a monochrome type or a color type.

The configuration and the function of the image forming apparatus 100 are described below with reference to FIG. 1.

Inside the image forming apparatus 100, a sheet storage tray 9 for storing a recording medium P is provided. The recording medium refers to a medium on which an image is formed by the image forming apparatus. Examples of a recording medium include paper, a plastic sheet, a cloth, an Overhead Projector (OHP) sheet, a label, and the like.

The recording media P stored in the sheet storage tray 9 are sent out, one by one, by a pickup roller 10 and is conveyed to a registration roller 12 by a transport roller 11.

When an image signal output from an external apparatus such as a PC is input, each of color components of the input image signal is applied, depending on its color, to one of optical scanning apparatuses 3Y, 3M, 3C, and 3K including a semiconductor laser and a polygon mirror. More specifically, a yellow component of the image signal received from the external apparatus is input to the optical scanning apparatus 3Y, and a magenta component of the image signal from the external apparatus is input to the optical scanning apparatus 3M. A cyan component of the image signal received from the external apparatus is input to the optical scanning apparatus 3C, and a black component of the image signal from the external apparatus is input to the optical scanning apparatus 3K. In the following description, a process and associated parts of the image forming apparatus will be described for a case in which a yellow image is formed. Note that images of other colors of magenta, cyan, and black are formed by a similar process.

The outer peripheral surface of a photosensitive drum 1Y is charged by a charger 2Y. After the outer peripheral surface of the photosensitive drum 1Y is charged, a laser beam corresponding to the component of the image signal input from the external apparatus to the optical scanning apparatus 3Y is emitted by the optical scanning apparatus 3Y, and the outer peripheral surface of the photosensitive drum 1Y is illuminated by the laser beam via an optical system including the polygon mirror. As a result, an electrostatic latent image is formed on the outer peripheral surface of the photosensitive drum 1Y.

Subsequently, the electrostatic latent image is developed with toner by a developer 4Y. As a result, a toner image is formed on the outer peripheral surface of the photosensitive drum 1Y. The toner image formed on the photosensitive drum 1Y is transferred to a transfer belt 6 by a transfer roller 5Y provided at a position facing the photosensitive drum 1Y.

In addition to the yellow toner image, magenta, cyan, and black toner images are also formed and transferred to the transfer belt in a similar manner. The yellow, magenta, cyan, and black toner images transferred to the transfer belt 6 are transferred to the recording medium P by transfer roller pairs 15a and 15b. To make it possible for the recording medium P to be subjected to the image transfer process described above, a registration roller 12 feeds, at a proper timing, the recording medium P to the transfer roller pairs 15a and 15b functioning as the transfer device.

After the toner image is transferred to the recording medium P in the above-described manner, the recording medium P is sent to a fixing device 16. The recording medium P is heated and pressurized by the fixing device 16 to fix the toner image on the recording medium P. Thus, the image is formed on the recording medium P by the image forming apparatus 100 in the above-described manner. The recording medium P on which the image has been formed is discharged to the outside of the image forming apparatus 100 by transport rollers 17, 18, 19, and 20.

The configuration and the function of the image forming apparatus 100 have been described above.

### Control Functions of Image Forming Apparatus

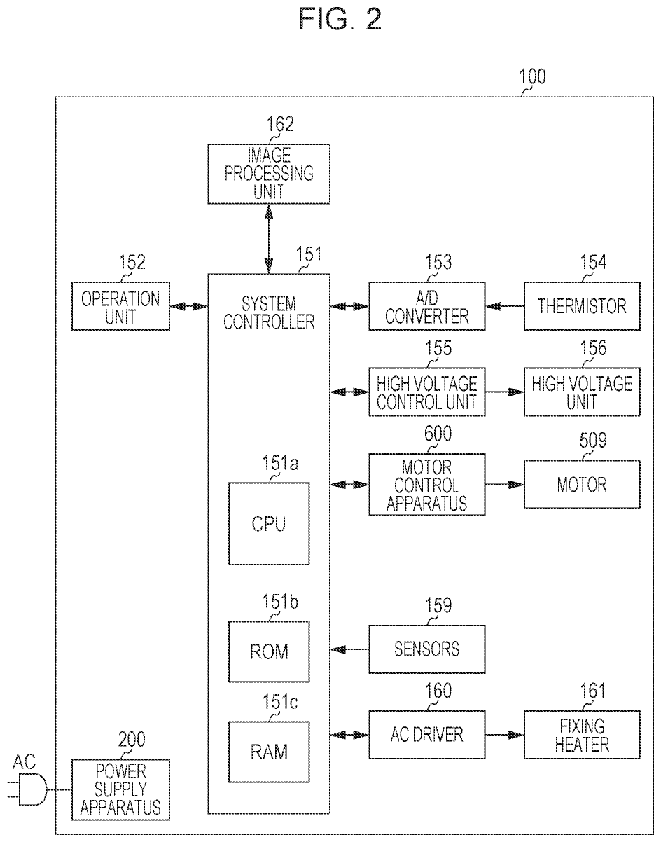

FIG. 2 is a control function block diagram of the image forming apparatus 100. As shown in FIG. 2, the image forming apparatus 100 includes a power supply apparatus 200. The power supply apparatus 200 is connected to an AC power supply (a commercial power supply) AC, and various apparatuses disposed in the image forming apparatus 100 are operated by electric power output from the power supply apparatus 200.

As shown in FIG. 2, a system controller 151 includes a Central Processing Unit (CPU) 151a, a Read Only Memory (ROM) 151b, and a Random Access Memory (RAM) 151c. The system controller 151 is connected to an image processing processor, circuit, or apparatus 162, an operation processor, device, or circuit 152, an analog/digital (A/D) converter 153, a high voltage control circuit 155, a motor control apparatus 600, sensors 159, and an AC driver 160. The system controller 151 can transmit and receive data, a command, and the like to and from each connected device or circuit.

The CPU 151a executes various processes related to a predetermined image formation sequence by reading and executing various programs stored in the ROM 151b.

The RAM 151c is a storage device. The RAM 151c stores, for example, various data such as a set value for a high voltage control circuit 155, a command value for the motor control apparatus 600, and information received from the operation circuit 152.

The system controller 151 transmits the set value data for various apparatuses disposed in the image forming apparatus 100, which is necessary for the image processing performed by the image processing circuit 162, to the image processing circuit 162. The system controller 151 also receives signals from the sensors 159 and controls the high voltage circuit 156 based on the received signals.

The high voltage control circuit 155 drives a high voltage circuit 156 (chargers 2Y, 2M, 2C, and 2K, developers 4Y, 4M, 4C, and 4K, transfer roller pairs 15a and 15b, etc.) according to a control signal output from the system controller 151.

The motor control apparatus 600 drives a motor 509 for driving the load provided in the image forming apparatus 100 in response to a command output by the CPU 151a.

The A/D converter 153 receives a detection signal output by a thermistor 154 for detecting the temperature of the fixing heater 161, converts the detection signal from an analog signal to a digital signal, and transmits the resultant detection signal to the system controller 151. The system controller 151 controls the AC driver 160 based on the digital signal received from the A/D converter 153. The AC driver 160 controls the fixing heater 161 such that the fixing heater 161 has a proper temperature at which the fixing process is performed. The fixing heater 161 is a heater used in the fixing process, and is included in the fixing device 16.

The system controller 151 controls the operation circuit 152 to display an operation screen for use by a user to set the type of recording medium to be used (hereinafter referred to as a paper type) on a display device provided on the operation circuit 152. The system controller 151 receives information set by the user from the operation circuit 152, and controls the operation sequence of the image forming apparatus 100 based on the information set by the user. Furthermore, the system controller 151 transmits information indicating the state of the image forming apparatus to the operation circuit 152. The information indicating the state of the image forming apparatus is, for example, information regarding the number of images formed, the status of the progress of the image forming operation, an occurrence of a jam or double feeding of sheets in an image printing apparatus and a document feeding apparatus. The operation circuit 152 displays the information received from the system controller 151 on the display device.

The system controller 151 controls the operation sequence of the image forming apparatus 100 in the above-described manner.

### Power Modes

The image forming apparatus 100 according to the present embodiment has a normal power mode and a power saving mode (sleep mode). In the normal power mode, it is allowed to form an image on a recording medium. In the power saving mode (the sleep mode), the number of loads to which power is supplied is smaller than in the normal power mode, and the power consumption in the power saving mode is smaller than in the normal power mode.

In the normal power mode, power is supplied from the power supply apparatus 200 to the operation circuit 152, the CPU 151a, the high voltage control circuit 155, the high voltage circuit 156, the motor control apparatus 600, the motor 509, the sensors 159, and the like such that it is possible to form an image on a recording medium.

On the other hand, in the power saving mode, power is supplied from the power supply apparatus 200 to the operation circuit 152 and the CPU 151a, but power is not supplied to the high voltage control circuit 155, the high voltage circuit 156, the motor control apparatus 600, and the motor 509, and thus the power consumption in the power saving mode is smaller than in the normal power mode.

The power mode may be switched by the CPU 151a from the normal power mode to the power saving mode, for example, when a predetermined time has elapsed since the end of the image forming job by the image forming apparatus 100. For example, when an error occurs in at least one of the high voltage control circuit 155, the high voltage circuit 156, the motor control apparatus 600, and the motor 509, the image forming process may be stopped and then the CPU 151a may switching the power mode from the normal power mode to the power saving mode.

The switching from the normal power mode to the power saving mode may be performed by the CPU 151a in response to a user pressing a power switch provided on the operation circuit 152a.

### Power Supply Apparatus

### Configuration and Operation of Power Supply Apparatus

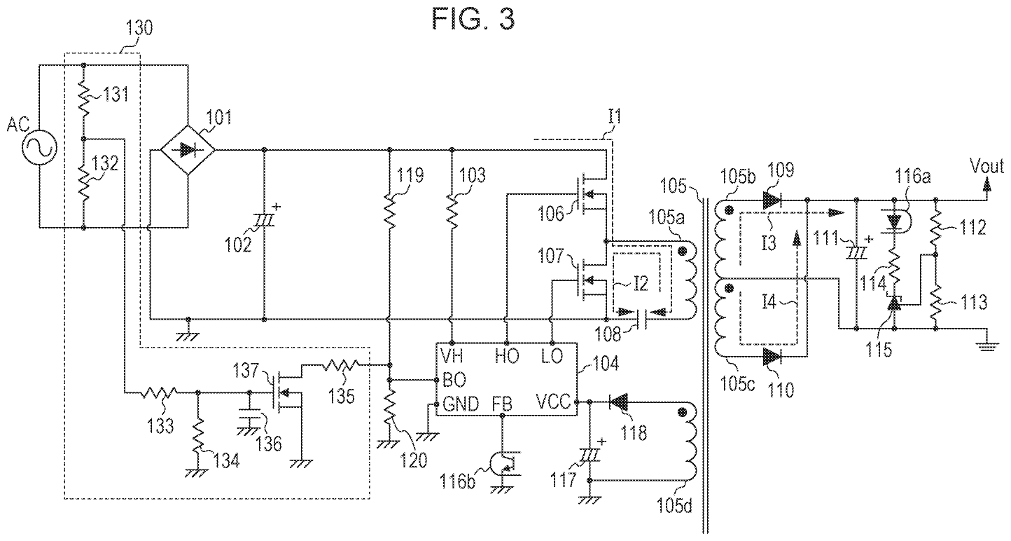

FIG. 3 is a diagram illustrating a configuration of the power supply apparatus 200. The power supply apparatus 200 is an ACDC power supply that converts an AC voltage supplied from a commercial power supply into a DC voltage by a current resonance method and outputs the resultant DC voltage.

The power supply apparatus 200 includes a circuit on a primary side to which the commercial power supply AC is connected, and a circuit on a secondary side isolated from the circuit on the primary side.

The commercial power supply AC is connected to a diode bridge 101, and a DC output terminal of the diode bridge 101 is connected to a smoothing capacitor 102. The diode bridge 101 is an instance or embodiment of a rectification circuit. A half bridge composed of a first switching device or circuit 106 and a second switching device or circuit 107 is connected in parallel with the smoothing capacitor 102 in a subsequent stage of the smoothing capacitor 102. A resonance circuit formed by a series connection of a primary winding 105a of a transformer 105 and a resonance capacitor 108 is connected in parallel to the second switching device or circuit 107. The resonance circuit composed of the primary winding 105a of the transformer 105 and the resonance capacitor 108 may be connected in parallel with the first switching device or circuit 106.

The transformer 105 is used to transmit power from the primary side to the secondary side while maintaining the isolation between the circuit on the primary side and the circuit on the secondary side. To achieve this, the primary winding 105a and the secondary windings 105b and 105c of the transformer 105 are wound on the same core. The inductance of the primary winding 105a of the transformer 105 includes a component coupled to the secondary windings 105b and 105c and a component (a leakage inductance) not coupled to the secondary windings 105b and 105c.

One end of the secondary winding 105b of the transformer 105 is connected to the ground on the secondary side, and the other end is connected to the anode of a rectifier diode 109. One end of the secondary winding 105c of the transformer 105 is connected to the ground on the secondary side, and the other end is connected to the anode of a rectifier diode 110.

The cathode of the rectifier diode 109 and the cathode of the rectifier diode 110 are connected to each other to have the same potential, and are connected to one end of the smoothing capacitor 111. The other end of the smoothing capacitor 111 is connected to the ground.

The AC voltage input to the power supply apparatus 200 is rectified by the diode bridge 101 and then smoothed by the smoothing capacitor 102 to generate a smoothed voltage. The DC voltage obtained as a result of smoothing is applied to a VH terminal of a converter control circuit 104 via a starting resistor 103.

The converter control circuit or conversion circuit 104 includes an HO terminal and an LO terminal from which to output pulse signals, or Pulse Width Modulation (PWM) signals, for driving the first switching circuit 106 and the second switching circuit 107. The first switching circuit 106 and the second switching circuit 107 are driven by the pulse signals output from the converter control circuit 104. The converter control circuit 104 alternately drives the first switching circuit 106 and the second switching circuit 107 at a duty ratio of 50%. That is, the converter control circuit 104 drives the first switching circuit 106 and the second switching circuit 107 such that the second switching circuit 107 is in the OFF state when the first switching circuit 106 is in the ON state, and the second switching circuit 107 is in the ON state when the first switching circuit 106 is in the OFF state. As a result, a square wave is applied to the resonance circuit composed of the primary winding 105a of the transformer 105 and the resonance capacitor 108, and an AC current flows through the primary winding 105a of the transformer 105.

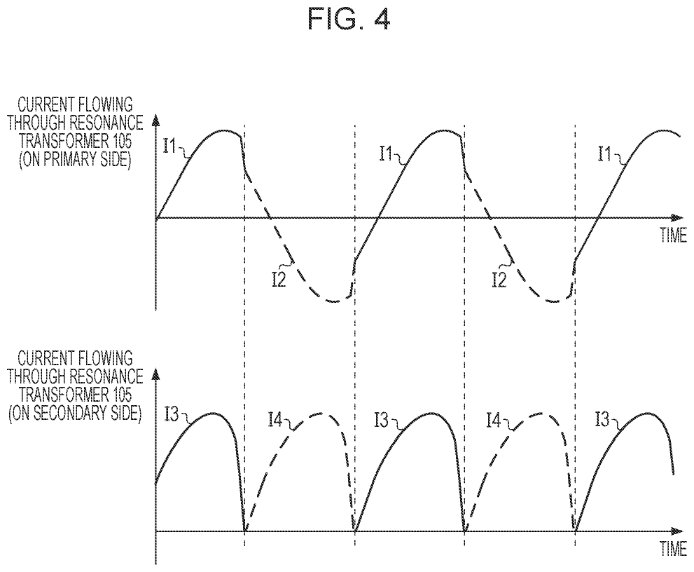

FIG. 4 is a diagram showing the current flowing through the primary winding 105a of the transformer 105 and the current flowing through the secondary windings 105b and 105c of the transformer 105.

When the first switching circuit 106 is in the ON state and the second switching circuit 107 is in the OFF state, a current I1 from the smoothing capacitor 102 flows through the first switching circuit 106, the primary winding 105a of the transformer, and the resonance capacitor 108 in this order. In this state, on the secondary side, a current I3 flows from the secondary winding 105b into the rectifier diode 109 and further into the smoothing capacitor 111.

On the other hand, when the first switching circuit 106 is in the OFF state and the second switching circuit 107 is in the ON state, a current I2 from the resonance capacitor 108 flows through the primary winding 105a of the transformer and further through the second switching circuit 107. In this state, on the secondary side, a current I4 flows from the secondary winding 105c into the rectifier diode 110 and further into the smoothing capacitor 111.

As a result of driving the first switching circuit 106 and the second switching circuit 107 in the above-described manner, an AC current flows through the primary winding 105a of the transformer 105, and a magnetic flux is generated by the AC current and the magnetic field penetrates the secondary windings 105b and 105c of the transformer 105 through the core of the transformer 105. The magnetic flux penetrating the secondary windings 105b and 105c induces an AC voltage in the secondary windings 105b and 105c, and the induced AC voltage causes AC currents to flow through the secondary windings 105b and 105c. The AC currents flowing through the secondary windings 105b and 105c are rectified by the rectifier diodes 109 and 110 and then smoothed by the smoothing capacitor 11. As a result, a DC voltage is obtained in the circuit on the secondary side. The voltage across the smoothing capacitor 111 provides an output voltage Vout of the power supply apparatus 200.

### Control of Output Voltage Vout

The output voltage Vout is input to a photocoupler light emitting device or circuit 116a. The output voltage Vout is divided by resistors 112 and 113 and input to a shunt regulator 115.

The shunt regulator 115 operates such that when the input voltage is higher than a reference voltage, the shunt regulator 115 increases the current flowing through the photocoupler light emitting device 116a, while when the input voltage is lower than the reference voltage, the shunt regulator 115 reduces the current flowing through the photocoupler light emitting device 116a. When a current flows through the photocoupler light emitting device 116a, the photocoupler light emitting device 116a emits light. The light emitted from the photocoupler light emitting device 116a is incident on a photocoupler light receiving device or circuit 116b. A current corresponding to the amount of received light flows through the photocoupler light receiving device 116b. That is, the photocoupler light emitting device 116a provided on the secondary side transmits information on the output voltage Vout to the circuit on the primary side while maintaining the isolation from the circuit on the primary side.

The output voltage Vout changes according to a drive frequency. More specifically, the output voltage Vout is given by the following equation (1).

$$Vout = \frac{VCIN \times M}{2 N} \qquad ( 1 )$$

In equation (1), N is the ratio of turns (N=N1/N2) between the number of turns N1 of the primary winding 105a and the number of turns N2 of the secondary winding 105b (105c), VCIN is the voltage across the smoothing capacitor 102, and M is the resonance circuit gain. The resonance circuit gain M is a function of the drive frequency and the load. That is, the output voltage Vout is a function of the drive frequency and the load.

The drive frequency by the converter control circuit 104 is given by the resonance frequency of the circuit on the primary side in a state in which the secondary windings 105b and 105c are short-circuited, and is expressed by the following equation (2).

$$f 1 = \frac{1}{2 π \sqrt{Llk \times C}} \qquad ( 2 )$$

In equation (2), Llk is an inductance (a leakage inductance) corresponding to a leakage flux of the primary winding 105a in the state where the secondary windings 105b and 105c are short-circuited, and C is the capacitance of the resonance capacitor 108. The range in which the drive frequency is lower than f0 is called a capacitance range in which the current resonance cannot occur.

The converter control circuit 104 controls the drive frequency by which to switch the first switching circuit 106 and the second switching circuit 107 based on the current flowing through the photocoupler light receiving device 116b connected to an FB terminal. That is, the converter control circuit 104 controls the drive frequency by which to switch the first switching circuit 106 and the second switching circuit 107 based on the current flowing through the photocoupler light receiving device 116b such that the output voltage Vout has a value corresponding to the reference voltage of the shunt regulator 115. More specifically, in a case where the current flowing through the photocoupler light receiving device 116b indicates that the output voltage Vout is smaller than the voltage corresponding to the reference voltage, the converter control circuit 104 reduces the drive frequency. In a case where the current flowing through the photocoupler light receiving device 116b indicates that the output voltage Vout is larger than the voltage corresponding to the reference voltage, the converter control circuit 104 increases the drive frequency.

### Converter Control Circuit

As shown in FIG. 3, the converter control circuit 104 includes a GND terminal, a VCC terminal, and a BO terminal in addition to the VH terminal, the HO terminal, the LO terminal, and the FB terminal. The GND terminal is connected to the ground.

The VCC terminal is connected to the positive electrode of the capacitor 117 and the cathode terminal of the diode 118. The negative electrode of the capacitor 117 is connected to the ground, and the anode terminal of the diode 118 is connected to the auxiliary winding 105d of the transformer 105.

The BO terminal is connected to the node between a resistor 119 and a resistor 120. The other end of the resistor 119 is connected to the positive electrode of the smoothing capacitor 102, and the other end of the resistor 120 is connected to the ground.

### Starting the Converter Control Circuit

The voltage smoothed by the smoothing capacitor 102 is input to the VH terminal of the converter control circuit 1041 via the starting resistor 103. When the voltage is input to the VH terminal, the voltage at the VCC terminal of the converter control circuit 104 (the voltage across the capacitor 117) rises.

The voltage smoothed by the smoothing capacitor 102 is also input to the BO terminal of the converter control circuit 104.

When the voltage input to the BO terminal functioning as an input terminal rises up to a threshold voltage (a specific voltage), the converter control circuit 104 starts outputting pulse signals from the HO terminal and the LO terminal. That is, the first switching circuit 106 and the second switching circuit 107 are driven in a state where the voltage input to the BO terminal is equal to or higher than the threshold voltage.

When the driving of the first switching circuit 106 and the second switching circuit 107 is started, a voltage is generated in the winding 105d. The voltage generated in the winding 105d is rectified and smoothed by the diode 118 and the capacitor 117, and the resultant voltage is supplied to the VCC terminal of the converter control circuit 104. When supplying of the power from the winding 105d to the VCC terminal is started, the converter control circuit 104 turns off the power supply from the VH terminal to the VCC terminal. That is, the converter control circuit 104 operates based on the voltage input to the VCC terminal.

### Input Voltage to BO Terminal

As shown in FIG. 3, the power supply apparatus 200 according to the present embodiment includes a switching circuit 130 for switching the magnitude of the voltage input to the BO terminal. The switching circuit 130 includes resistors 131, 132, 133, 134, and 135, a capacitor 136, and a third switching circuit 137.

The resistor 131 and the resistor 132 are connected in series to each other, and the resultant series connection of the resistor 131 and the resistor 132 is connected in parallel to the AC power supply AC. One end of the resistor 133 is connected to the node between the resistor 131 and the resistor 132, and the other end of the resistor 133 is connected to the gate terminal of the third switching circuit 137.

One end of the resistor 134 is connected to the gate terminal of the third switching circuit 137, and the other end of the resistor 134 is connected to the ground. One end of the capacitor 136 is connected to the gate terminal of the third switching circuit 137, and the other end of the capacitor 136 is connected to the ground.

The drain terminal of the third switching circuit 137 is connected to the BO terminal of the converter control circuit 104 via the resistor 135, and the source terminal of the third switching circuit 137 is connected to the ground.

When the AC voltage from the AC power supply AC is input to the power supply apparatus 200, the third switching circuit 137 is in the ON state. As a result, the voltage smoothed by the smoothing capacitor 102 is divided by the resistors 119 and 120 and the resistor 135 of the switching circuit 130, and the voltage after the division is input to the BO terminal. The voltage VBO input to the BO terminal is given by the following equation (3) in which R119 denotes the resistance value of the resistor 119, R120 denotes the resistance value of the resistor 120, R135 denotes the resistance value of the resistor 135, and CVIN denotes the voltage smoothed by the smoothing capacitor 102.

$$VBO = \frac{\frac{R 135 + R 120}{R 135 \times R 120}}{R 119 + \frac{R 135 + R 120}{R 135 \times R 120}} \times VCIN \qquad ( 3 )$$

That is, the voltage VBO input to the BO terminal is the voltage obtained by dividing the voltage VCIN smoothed by the smoothing capacitor 102 by a first voltage dividing ratio represented by R119, R120, and R135 on the right side of the equation (3). Note that the voltage dividing ratio is the ratio of VBO to VCIN.

On the other hand, when the AC voltage from the AC power supply AC is not input to the power supply apparatus 200, the third switching circuit 137 is in the OFF state. As a result, the voltage smoothed by the smoothing capacitor 102 is divided by the resistors 119 and 120, and the resultant divided voltage is input to the BO terminal. The voltage VBO input to the BO terminal is given by the following equation (4).

$$V B O = \frac{R 120}{R 119 + R 120} \times VCIN \qquad ( 4 )$$

That is, the voltage VBO input to the BO terminal is the voltage obtained by dividing the voltage VCIN smoothed by the smoothing capacitor 102 by a second voltage dividing ratio represented by R119 and R120 on the right side of the equation (3). Note that the first voltage dividing ratio is smaller than the second voltage dividing ratio.

That is, in the present embodiment, the voltage input to the BO terminal in the state in which the AC voltage from the AC power supply AC is input to the power supply apparatus 200 is smaller than the voltage input to the BO terminal in the state in which the AC voltage from the AC power supply AC is not input to the power supply apparatus 200. Operation when AC voltage is cut off

Next, a description is given of the operation of the power supply apparatus 200 in the state in which the AC voltage is cut off. In the present embodiment, when the AC voltage from the commercial power supply is cut off, the smoothing capacitor is discharged in a manner described below.

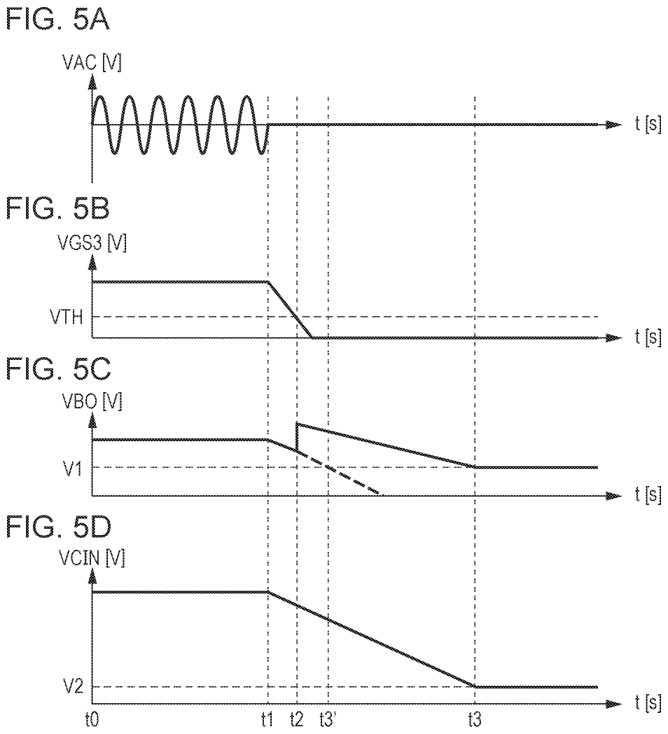

FIGS. 5A to 5D are time charts related to the operation of the power supply apparatus 200 when the AC voltage input to the power supply apparatus 200 is cut off.

FIG. 5A is a diagram showing an AC voltage VAC. FIG. 5B is a diagram showing the gate-source voltage VGS of the third switching circuit 137. FIG. 5C is a diagram showing the voltage VBO input to the BO terminal of the converter control circuit 104. FIG. 5D is a diagram showing the voltage VCIN.

When t0≤t<t1

As shown in FIG. 5A, in a period from time t0 to time t1, the AC voltage is input to the power supply apparatus 200 from the AC power supply AC. In the present embodiment, as shown in FIG. 5B, the gate-source voltage VGS of the third switching circuit 137 is larger than the gate voltage VTH in a state where the AC voltage is input to the power supply apparatus 200 from the AC power supply AC. That is, during the period from time t0 to time t1, the third switching circuit 137 is in the ON state, and the voltage smoothed by the smoothing capacitor 102 is divided by the first voltage dividing ratio and input to the BO terminal of the converter control circuit 104.

As shown in FIG. 5D, during the period from time t0 to time t1, the AC voltage is input to the power supply apparatus 200 from the AC power supply AC, and thus the smoothing capacitor 102 is charged and the voltage VCIN is maintained at a constant value. As a result, as shown in FIG. 5C, during the period from time t0 to time t1, a constant voltage corresponding to the voltage VCIN is input to the BO terminal of the converter control circuit 104. In the present embodiment, the voltage input to the BO terminal is larger than the threshold voltage V1. That is, during the period from time t0 to time t1, the first switching circuit 106 and the second switching circuit 107 are driven by the converter control circuit 104.

When t1≤t<t2

When the AC voltage from the AC power supply AC is cut off at time t1, the gate-source voltage VGS of the third switching circuit 137 decreases. Note that in the present embodiment, as shown in FIG. 5B, the gate-source voltage VGS from time t1 to time t2 is larger than the gate voltage VTH. That is, during the period from time t1 to time t2, the third switching circuit 137 is in the ON state, and the voltage smoothed by the smoothing capacitor 102 is divided by the first voltage dividing ratio and input to the BO terminal of the converter control circuit 104.

Note that in the present embodiment, the voltage input to the BO terminal of the converter control circuit 104 during the period from time t1 to time t2 is larger than the threshold voltage V1. That is, during the period from time t1 to time t2, the first switching circuit 106 and the second switching circuit 107 are driven by the converter control circuit 104.

As described above, the AC voltage from the AC power supply AC is cut off during the period from time t1 to time t2. That is, during the period from time t1 to time t2, the first switching circuit 106 and the second switching circuit 107 are driven by the converter control circuit 104, and, as a result, the voltage VCIN is applied to the winding of the transformer 105. That is, during the period from time t1 to time t2, the charge stored in the smoothing capacitor 102 is consumed by driving the first switching circuit 106 and the second switching circuit 107. As a result, the voltage VCIN decreases. As shown in FIG. 5C, during the period from time t1 to time t2, as the voltage VCIN decreases, the voltage input to the BO terminal of the converter control circuit 104 decreases.

During the period from time t1 to time t2, the current flowing on the secondary side caused by the voltage generated in the windings 105b and 105c flows, for example, toward the ground in the circuit on the secondary side.

When t2≤t<t3

When the gate-source voltage VGS of the third switching circuit 137 becomes lower than the gate voltage VTH at time t2 as a result of the reduction caused by the cutoff of the AC voltage from the AC power supply AC, the third switching circuit 137 turns off. As a result, a voltage obtained by dividing the voltage smoothed by the smoothing capacitor 102 by the second voltage dividing ratio is input to the BO terminal of the converter control circuit 104. As a result, as shown in FIG. 5C, at time t2, an increase occurs in the voltage input to the BO terminal of the converter control circuit 104.

Note that in the present embodiment, the voltage input to the BO terminal of the converter control circuit 104 during the period from time t2 to time t3 is larger than the threshold voltage V1. That is, during the period from time t2 to time t3, the first switching circuit 106 and the second switching circuit 107 are driven by the converter control circuit 104.

During the period from time t2 to time t3, the AC voltage from the AC power supply AC is in the cut-off state. That is, during the period from time t2 to time t3, the first switching circuit 106 and the second switching circuit 107 are driven by the converter control circuit 104 and thus the voltage VCIN is applied to the winding of the transformer 105. That is, during the period from time t2 to time t3, the charge stored in the smoothing capacitor 102 is consumed by driving the first switching circuit 106 and the second switching circuit 107.

As a result, the voltage VCIN decreases. As shown in FIG. 5C, during the period from time t2 to time t3, as the voltage VCIN decreases, the voltage input to the BO terminal of the converter control circuit 104 decreases.

When t3≤t

When the voltage input to the BO terminal of the converter control circuit 104 reaches the threshold voltage V1 at time t3, the converter control circuit 104 stops driving the first switching circuit 106 and the second switching circuit 107. When the operation of the converter control circuit 104 is stopped, the power stored in the smoothing capacitor 102 is no longer consumed, and thus the voltage VCIN becomes equal to a specific voltage V2, and the voltage input to the BO terminal of the converter control circuit 104 becomes equal to V1.

When the driving of the first switching circuit 106 and the second switching circuit 107 is stopped, no voltage is generated in the winding 105d. As a result, the voltage input to the VCC terminal of the converter control circuit 104 drops, and the operation of the converter control circuit 104 is stopped.

As described above, in the present embodiment, the switching circuit 130 operates such that the voltage input to the BO terminal when the AC voltage is not input to the power supply apparatus 200 is larger than when the AC voltage is input to the power supply apparatus 200 is larger than. That is, when the AC voltage is cut off, the voltage input to the BO terminal increases.

In a case where the present embodiment is not used, the voltage VBO input to the BO terminal becomes smaller than the threshold voltage V1 at time t3′, as represented by a broken line in FIG. 5C. That is, when the present embodiment is used, the period (from t2 to t3) during which the first switching circuit 106 and the second switching circuit 107 are driven still after the AC voltage is cut off is longer than a period (t2 to t3′) during which a similar state occurs when the present embodiment is not used. As a result, the discharging of the charge stored in the smoothing capacitor 102 by driving the first switching circuit 106 and the second switching circuit 107 can be continued over a longer time. That is, the smoothing capacitor can be discharged more efficiently in the state where the AC voltage from the commercial power supply is cut off. Furthermore, since no resistor for discharging the smoothing capacitor is connected in parallel with the smoothing capacitor, it is possible to prevent an unnecessary current from flowing during the normal operation of the power supply apparatus 200.

In the present embodiment, the threshold voltage V1 may be set, for example, as follows. That is, the threshold voltage V1 is set such that after the voltage VCIN rises up to a relatively high voltage (for example, 200 V), the voltage input to the BO terminal reaches the threshold voltage V1. As a result, the driving of the first switching circuit 106 and the second switching circuit 107 is started when the voltage smoothed by the smoothing capacitor 102 is relatively low, which prevents a large current from flowing through the first switching circuit 106 and the second switching circuit 107. That is, it is possible to reduce the probability that a failure occurs in the first switching circuit 106 or the second switching circuit 107.

Alternatively, in the present embodiment, the threshold voltage V1 may be set as follows. That is, the threshold voltage V1 may be set such that when the voltage input to the BO terminal reaches the threshold voltage V1 and the operation of the converter control circuit 104 stops, the voltage VCIN has a voltage value (for example, 50 V) that does not cause an operator to have an electric shock. This makes it possible to prevent the operator from getting an electric shock when the operator replaces a board of the power supply apparatus 200 after the AC voltage is cut off. Note that the threshold voltage may be set to 0 V.

The supply of the AC voltage from the commercial power supply to the power supply apparatus 200 is turned off, for example, when the plug of the image forming apparatus is unplugged from the power supply outlet.

When the power mode of the image forming apparatus is switched to the sleep mode, the supply of the AC voltage from the commercial power source to the power supply apparatus 200 may be cut off by switching circuit. More specifically, for example, the AC voltage supply from the commercial power supply to the power supply apparatus 200 is cut off by the CPU 151a by turning off the switching circuit connected in series with the AC power supply AC.

Note that the chargers 2Y, 2M, 2C, and 2K, the developer 4Y, 4M, 4C, and 4K, the transfer rollers 5Y, 5M, 5C, and 5K, and the transfer roller pairs 15a and 15b are included in the image forming apparatus, processor, or circuit.

According to the present disclosure, the smoothing capacitor can be discharged in the state where the AC voltage from the commercial power supply is cut off.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2021-037804 filed Mar. 9, 2021, which is hereby incorporated by reference herein in its entirety.

What is claimed is:

1. A power supply apparatus that converts an AC voltage from a power supply to a DC voltage, comprising:
a rectification circuit configured to rectify the AC voltage;
a smoothing capacitor configured to smooth the rectified AC voltage to produce a smoothed voltage;
a transformer including a first winding to which the smoothed voltage is applied, and a second winding isolated from the first winding;
a conversion circuit configured to convert a voltage, generated in the second winding caused by the smoothed voltage being applied to the first winding, into the DC voltage;
a switching circuit configured to switch between a first state in which the smoothed voltage is applied to the first winding and a second state in which the smoothed voltage is not applied to the first winding;
a voltage dividing circuit configured to divide the smoothed voltage to generated a divided voltage; and
a controller including an input terminal to which the divided voltage is input and being configured to control switching between an ON state and an OFF state of the switching circuit in a state where the divided voltage is larger than a predetermined voltage,
wherein the voltage dividing circuit divides the smoothed voltage by a first voltage dividing ratio in a case where the AC voltage is being input to the power supply apparatus, the voltage dividing circuit divides the smoothed voltage by a second voltage dividing ratio larger than the first voltage dividing ratio in a case wherein the AC voltage is not being input to the power supply apparatus, the first voltage dividing ratio and the second voltage dividing ratio each being defined by a ratio of the divided voltage to the smoothed voltage.

2. The power supply apparatus according to claim 1, wherein
the voltage dividing circuit includes a first resistor connected to the smoothing capacitor, a second resistor connected in series with the first resistor, a third resistor connected in parallel with the second resistor, and a second switching circuit connected to the third resistor,
the input terminal is connected to a node between the first resistor and the second resistor,
the second switching circuit is in the ON state when the AC voltage is being input to the power supply apparatus, the second switching circuit is in the OFF state when the AC voltage is not being input to the power supply apparatus, and
the second switching circuit being in the ON state causes the smoothed voltage to be divided by the first resistor, the second resistor and the third resistor when the AC voltage is being input to the power supply apparatus, the second switching circuit being in the OFF state causes the smoothed voltage to be divided by the first resistor and the second resistor when the AC voltage is not being input to the power supply apparatus.

3. The power supply apparatus according to claim 1, wherein
the transformer further includes a third winding isolated from the first winding and the second winding, and
when the AC voltage is not being input to the power supply apparatus, the controller operates based on a voltage generated in the third winding as a result of controlling the switching of the switching circuit between the ON state and the OFF state.

4. The power supply apparatus according to claim 1, wherein
when the divided voltage is smaller than the predetermined voltage, the controller does not switch the state of the switching circuit between the ON state and the OFF state.

5. An image forming apparatus comprising:
a power supply apparatus; and
an image forming circuit configured to form an image on a recording medium based on a DC voltage output from the power supply apparatus,
the power supply apparatus comprising:
a rectification circuit configured to rectify an AC voltage input from a power supply;
a smoothing capacitor configured to smooth the rectified AC voltage to generate a smoothed voltage;
a transformer including a first winding to which the smoothed voltage is applied, and a second winding isolated from the first winding;
a conversion circuit configured to convert a voltage, generated in the second winding caused by the voltage being applied to the first winding, into the DC voltage;
a switching circuit configured to switch between a first state in which the smoothed voltage is applied to the first winding and a second state in which the smoothed voltage is not applied to the first winding;
a voltage dividing circuit configured to divide the smoothed voltage to generate a divided voltage; and
a controller including an input terminal to which the divided voltage is input and being configured to control switching between an ON state and an OFF state of the switching circuit in a state where the divided voltage is larger than a predetermined voltage,
wherein the voltage dividing circuit divides the smoothed voltage by a first voltage dividing ratio in a case where the AC voltage is being input to the power supply apparatus, the voltage dividing circuit divides the smoothed voltage by a second voltage dividing ratio larger than the first voltage dividing ratio in a case wherein the AC voltage is not being input to the power supply apparatus, the first voltage dividing ratio and the second voltage dividing ratio each being defined by a ratio of the divided voltage to the smoothed voltage.

6. The power supply apparatus according to claim 5, wherein
the voltage dividing circuit includes a first resistor connected to the smoothing capacitor, a second resistor connected in series with the first resistor, a third resistor connected in parallel with the second resistor, and a second switching circuit connected to the third resistor,
the input terminal is connected to a node between the first resistor and the second resistor,
the second switching circuit is in the ON state when the AC voltage is being input to the power supply apparatus, while the second switching circuit is in the OFF state when the AC voltage is not being input to the power supply apparatus, and
the second switching circuit being in the ON state causes the smoothed voltage to be divided by the first resistor, the second resistor and the third resistor when the AC voltage is being input to the power supply apparatus, the second switching circuit being in the OFF state causes the smoothed voltage to be divided by the first resistor and the second resistor when the AC voltage is not being input to the power supply apparatus.

7. The power supply apparatus according to claim 5, wherein
the transformer further includes a third winding isolated from the first winding and the second winding, and
when the AC voltage is not being input to the power supply apparatus, the controller operates based on a voltage generated in the third winding as a result of controlling the switching of the switching circuit between the ON state and the OFF state.

8. The power supply apparatus according to claim 5, wherein
when the divided voltage is smaller than the predetermined voltage, the controller does not switch the state of the switching circuit between the ON state and the OFF state.
